(19) United States
(12) Patent Application Publication
(10) Pub. No.: US 2009/0044396 A1
(43) Pub. Date: Feb. 19, 2009

(54) CORROSION RESISTING PIPELINES

(75) Inventor: Peter Johnstone, Victoria (AU)

Correspondence Address: FITZPATRICK CELLA HARPER & SCINTO, 30 ROCKEFELLER PLAZA, NEW YORK, NY, 10112, US

(73) Assignee: FIRST GREEN PARK PTY LTD ET AL, Humevale (AU)

(21) Appl. No.: 11/659,224

(22) PCT Filed: Aug. 1, 2005
(86) PCT No.: PCT/AU2005/001133

§ 371 Date: Aug. 29, 2008

(30) Foreign Application Priority Data
Aug. 3, 2004 (AU) 2004904365

(51) Int. Cl. B21D 39/03; F16L 9/14

(52) U.S. Cl. 29/428; 138/143; 138/144

(57) ABSTRACT

The specification discloses both a method of protecting a metal pipeline length (10) from corrosion, in use, and such a pipeline length (10) produced by the method, the method involving winding at least one plastics material web (14, 16) under tension in a plurality of at least partially adhering overlapping spiral windings (20) to form a barrier layer (17) around the pipe (10) to prevent moisture penetrating from an outer surface of the barrier layer (17) to an outer surface (24) of the pipe (10), the pipeline length further having an outer protective layer (21) also formed by winding plastics film web about the pipeline length, the webs forming the protective layer (21) being more loosely wound than those forming the barrier layer (17).

The present invention relates to improvements in protection against corrosion for steel and cast or ductile iron pipes intended for underground installation. Specifically the present invention relates to an improved method of protecting such pipes and to a pipeline or pipe length protected in accordance with the present invention.

There are a number of known methods and arrangements for protecting such pipelines, each of which has certain advantages and also certain disadvantages. One known method involves bonded coating of the pipeline lengths typically with an epoxy coating material such as coal tar epoxy. A somewhat similar alternative might be to extrude a polyethylene or polypropylene coating over the pipe surface. To be effective, the coating, over its life must be completely free from pin holes, cracks or other similar damage and must also be capable of resisting deterioration that might cause such damage. Such defects, should they occur, cause concentration cells that tend to accelerate corrosion attack in their vicinity. Such bonded coatings are normally factory applied distant from the intended pipeline site and handling or mishandling during transport to the pipeline installation site increasing the risk of such defects occurring and even if noticed, such defects are difficult and time consuming to adequately repair at the pipeline installation site.

Cathodic pipeline protection systems are a potential second form of protection for underground pipelines subject to corrosion. The two basic types of cathodic protection systems, sacrificial-anode and impressed-current systems, involve installing anodes that are intended to corrode rather than the pipeline. Both systems require electrical continuity of the pipeline to ensure complete protection. In addition to cathodic pipeline protection, the pipeline might also be coated or encased with a dielectric material, or bonded coating, to reduce the amount of current required to provide protection. Cathodic pipeline protection systems are not particularly useful where the pipeline lengths are formed by electrically discontinuous rubber gasketed joints or where numerous valves, fittings and service connections exist along the pipeline length. Moreover cathodic protection systems are quite expensive to install and moreover, have an ongoing operational cost.

A third possible method is to utilise polyethylene encasement of the pipeline, typically utilising on site a reasonably loose fitting polyethylene sleeve to surround the pipeline. Such a system is quite low cost and even with small pin holes or similar defects, does not normally set up local galvanic corrosion cells. Also, once the pipeline has been buried, the polyethylene sleeve is pressed against the pipe wall providing a uniform environment for the pipe which may allow a small amount of ground water ingress but which does not necessarily result in excessive corrosion. The polyethylene sleeve also shields the pipe from low-level stray direct current. This system may not, in all situations, provide the degree of protection required and construction conditions, in some applications may also prevent this method being utilised.

The objective of the present invention is to provide an improved method of protecting steel and cast or ductile iron pipes against corrosion in underground applications and a pipe length or pipeline so protected.

Accordingly, the present invention provides a method of protecting metal, preferably a steel or iron, pipeline length intended for installation underground against corrosion, said method involving winding at least one plastics material film web under pressure in a plurality of overlapping spiral windings whereby said film web or webs adhere to one another to form a barrier layer arranged to prevent moisture penetrating from an outer surface of said barrier layer to an outer surface of said pipeline length.

Preferred features of the present invention may be as defined in claims 2 to 17 annexed hereto, the subject matter of these claims being hereby made part of the disclosure of this specification.

The present invention anticipates providing a pipeline length made in accordance with the method outlined above.

In accordance with a second aspect, the present invention also provides a metal, preferably a steel or iron (typically cast or ductile iron), pipeline length having at least one plastics material film web wound under pressure in a plurality of overlapping spiral windings onto an outer surface of said pipeline length to form a barrier layer adapted, in use, to prevent ground moisture penetrating from an outer surface of said barrier layer to the outer surface of said pipeline length.

Preferred features of this further aspect may be as defined in claims 20 to 22 annexed hereto, the subject matter of which claims are hereby incorporated into the disclosure of this specification by this reference thereto.

The present invention provides a system where a reliable barrier layer can be created on the pipeline length that is capable of preventing any ingress of ground moisture into the zone between the barrier layer and the pipeline outer surface itself. In a preferred embodiment, the barrier layer may be made from polyethylene film layers that will resist pin hole or other similar defects, however, even should they occur, galvanic corrosion cells should not be created. In a still further preferred arrangement, providing the additional protective layer as described will allow the protective barrier layer materials to be protected during transport (if needed) and during installation, thereby improving the corrosion resistance performance of the proposed system.

Several preferred embodiments of the present invention will now be described with reference to the accompanying drawings in which:

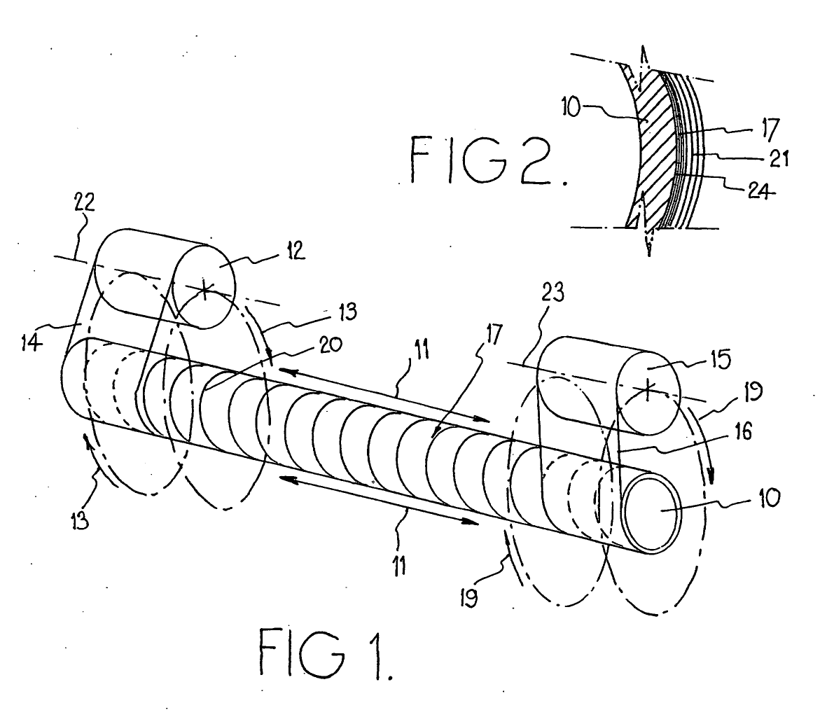

FIG. 1 is a schematic perspective view of one possible means for producing the corrosion resisting barrier layer in accordance with the present invention; and

FIG. 2 is a partial cross-section through the wall of the pipeline and the barrier and protective layers have been applied.

FIG. 1 of the annexed drawings illustrates schematically a method of applying a corrosion resistive barrier layer 17 to a metal (steel or cast/ductile iron) pipe. Apparatus supports the pipeline length 10 by any suitable means (not shown) for longitudinal movement in the direction of arrows 11. A roll of plastics material film web 12 may be provided supported on a circulating carriage for movement in the direction of arrows 13 about the pipeline length 10 while laying a web 14 onto the pipeline length as it moves in the direction of arrows 11 so as to form overlapping spiral windings 20 on the pipeline length 10. The aim is to apply the web 14 under pressure so that a tight engagement is achieved with the pipeline length outer surface 24 or a previously applied region of the web 14. As an alternative, the pipeline length 10 might be rotated about its longitudinal axis rather than having the film roll 12 move circumferentially about the pipeline length 10. In a further possible alternative, the roll 12 of plastics material film web 14 might be moved axially of the pipe 10 when laying the web 14 onto the pipe outer surface. If desired, multiple film web rolls may be utilised as illustrated at 15 to apply separate webs 16 to the pipeline length 10 or a previously applied web region on the pipe 10. Such further rolls 15 of film web 16 might also rotate about the pipe 10 in the direction shown schematically by arrow 19. The film web rolls 12, 15 are shown with their axes of rotation 22, 23 generally parallel to the axis of the pipe 10, however, they may also be angled relative to this direction. The film webs 14, 16 may be provided at similar spiral spacings but still overlapping or they may be applied with differing pitch so that an angle occurs between overlapping web layers. The overlapping film web layers might also be arranged crossing one another. Preferably, the innermost regions of the applied film web or webs also adhere to the outer surface of the pipeline length 10, although this is not essential. The closely overlapping regions of the webs 14, 16 form a barrier layer 17 that will prevent, in use, the ingress of ground moisture reaching the outer surface of the pipeline length 10.

The film web layers might be built up in the barrier layer 17 to achieve a desired performance characteristic by repeated passages of the pipeline length 10 past the rolls 12, 15 either in a forward direction or forward and reverse directions and the speed of movement of the pipeline length past the rolls 12, 15 may be adjusted to vary the pitch of the spiral windings 20.

Preferably, the film webs 14, 16 are polyethylene or more particularly, low density polyethylene that will adhere to itself or to other surfaces. Additives may be included in the formulation of the plastics material to improve its ability to adhere to itself or to previously applied film web surfaces. Other additives might also be included to improve resistance to degradation over time. In an alternative, co-extruded film webs might be used where the outer layers of the film web are polyethylene and at least one inner layer is an oxygen barrier layer formed by evoh, nylon or the like.

In one preferred embodiment, the film webs 14, 16 might be linear low density polyethylene that has been stretched beyond its yield point to increase its length and decrease its thickness which has then been partially relaxed to retain a degree of elastic deformation in its stored condition. Use of this type of film web material will allow the film web to be applied to the pipe under pressure and once applied, the film web will continue to constrict to apply further pressure to the pipeline length.

The barrier layer 17 might be applied at the pipeline installation site or alternatively at a factory remote from the installation site and transported to the installation site. In either case, it might also be considered desirable to provide further mechanical protection for the barrier layer 17. This might be achieved by providing further layers of plastics material film web that is wound onto the pipeline length over the barrier layer with much less pressure than the webs forming the barrier layer 17 to build up a protective layer 21 of greater thickness than the barrier layer. Conveniently a plurality of air pockets might be included between the webs forming the protective layer 21 to increase the cushioning and protective effect of the layer 21. The film web or webs forming the protective layer 21 might be the same as or different to those forming the barrier layer 17, however, it is desirable that they at least partially adhere to one another at least localised regions such that the outer protective layer remains as a coherent protective covering during transport (if needed) and pipeline installation.

Steel or ductile/cast iron pipeline lengths are normally joined to form the desired pipeline by welding or by the use of elastomeric sealing rings with appropriate cooperating mechanical connection means to join the lengths together. Such joins in the pipeline lengths might be protected in a similar manner to existing systems, for example by the use of sleeves overlying the joint region that might be heat shrunk into place. If conditions allow, the joint regions might be over wound with plastics film web in a similar manner to the pipeline length itself. Any other known method of protecting the join regions might also be used. If further protection is desired a loose polyethylene sleeve might be used to encase the whole pipeline that has been protected by the use of a barrier layer 17 as discussed in the foregoing.

1. A method of protecting a metal pipeline length intended for installation underground against corrosion, said method involving winding at least one self adhesive plastics material film web under pressure in a plurality of overlapping spiral windings without a separate adhesive material or layer between adjacent layers of said film web or webs onto an outer surface of said pipeline length whereby said film web or webs adhere to one another and are of sufficient layer numbers to form a barrier zone arranged to prevent moisture penetrating from an outer surface of said barrier zone to the outer surface of said pipeline length.

2. A method according to claim 1 wherein inner film web or webs of said barrier zone is/are adhered to the outer surface of said pipeline length.

3. A method according to claim 1 wherein the or each said plastics material film web is polyethylene.

4. A method according to claim 3 wherein the polyethylene is linear low density polyethylene.

5. A method according to claim 1 wherein the or each said plastics material film web is a multilayer co-extruded film web having opposed outer layers of a self adhesive polyethylene and an inner layer acting as an oxygen transmission barrier layer.

6. A method according to claim 5 wherein the oxygen transmission barrier layer is evoh or nylon.

7. A method according to claim 1 wherein the or each said plastics material film web includes additives to improve self-adhesion qualities and to resist degradation.

8. A method according to claim 1 wherein the or each said plastics material film web is initially stretched beyond its yield point to increase its length and decrease its thickness and thereafter allowed to partially relax to retain a portion of the elastic deformation in said film web or webs prior to application to said pipeline length.

9. A method according to claim 1 wherein a later applied said film web in said barrier layer is wound at a spiral angle different to that of a previously applied said film web.

10. A method according to claim 9 wherein the later applied said film web transversely crosses the previously applied said film web.

11. A method according to claim 1 wherein at least one further plastics material film web is wound in a plurality of overlapping spiral windings over said barrier layer with the further plastics material web or webs being at least partially adhered to one another to form a second outer protective zone.

12. A method according to claim 11 wherein said second outer protective layer is at least partially adhered to said barrier zone.

13. A method according to claim 11 wherein a reinforcing material web is wound with the further plastics material web or webs over said barrier zone.

14. A method according to claim 11 wherein the further plastics material film web or webs are wound more loosely than the plastics material film web or webs forming said barrier zone.

15. A method according to claim 11 wherein a plurality of air pockets or spaces are provided between overlying regions of the or each said further plastics material film web in said second outer protective zone.

16. A method according to claim 1 wherein, in use, a plastics material film sleeve loosely surrounds said pipeline length.

17. A pipeline length made by a method as defined in claim 1.

18. A metal pipeline length having at least one self adhesive plastics material film web wound under pressure in a plurality of overlapping spiral windings without a separate adhesive material or layer between adjacent layers of said film web or webs onto an outer surface of said pipeline length with sufficient layer numbers to form a barrier zone adapted, in use, to prevent moisture penetrating from an outer surface of said barrier zone to the outer surface of said pipeline length.

19. A pipeline length according to claim 18 wherein said pipeline length is made from steel or iron.

20. A pipeline length according to claim 18 wherein said barrier layer is adhered to said outer surface of the pipeline length.

21. A pipeline length according to claim 18 wherein at least one further plastics material film web is wound in a plurality of overlapping spiral windings over said barrier zone with the further film web or webs being at least partially adhered to one another to form a second outer protective zone.

22. A pipeline length according to claim 21 wherein the further plastics material film web or webs forming said second outer protective zone are wound more loosely than the plastics material film web or webs forming said barrier zone.

23. A method of protecting a metal pipeline length intended for installation underground against corrosion, said method involving winding at least one self adhesive plastics material film web under pressure in a plurality of overlapping spiral windings without a separate adhesive material or layer between adjacent layers of said film web or webs onto an outer surface of said pipeline length whereby said film web or webs adhere to one another and are of sufficient layer numbers to form a barrier zone arranged to prevent moisture penetrating from an outer surface of said barrier zone to the outer surface of said pipeline length, said method further including winding at least one further plastics material film web in a plurality of overlapping spiral windings over said barrier zone with said further plastics material web or webs being at least partially adhered to one another to form a second outer protective zone having a plurality of air pockets or spaces provided between overlying regions of the or each said further plastics material film web in said second outer protective zone.

24. A method of protecting a metal pipeline length intended for installation underground against corrosion, said method involving winding at least one self adhesive plastics material film web under pressure in a plurality of overlapping spiral windings without a separate adhesive material or layer between adjacent layers of said film web or webs onto an outer surface of said pipeline length whereby said film web or webs adhere to one another and are of sufficient layer numbers to form a barrier zone arranged to prevent moisture penetrating from an outer surface of said barrier zone to the outer surface of said pipeline length, said method further including winding at least one further plastics material film web more loosely than the plastics material film web or webs forming said barrier zone in a plurality of overlapping spiral windings over said barrier zone with said barrier zone with said further plastics material web or webs being at least partially adhered to one another to form a second outer protective zone.

25. A method according to claim 23 wherein the or each said plastics material film web forming the barrier zone is initially stretched beyond its yield point to increase its length and decrease its thickness and thereafter allowed to partially relax to retain a portion of the elastic deformation in said film web or webs prior to application to said pipeline length whereby said film web or webs will further apply pressure to said pipeline length after application thereto.

26. A method according to claim 23 claim wherein the or each said plastics material film web forming the barrier zone is a multilayer co-extruded film web wherein at least one layer of the co-extruded film web acts as an oxygen transmission barrier layer.

27. A method according to claim 26 wherein said one layer is an inner layer and opposed outer layers of a self adhesive polyethylene plastics material are provided outwardly of said one layer.

28. A metal pipeline length having at least one self adhesive plastics material film web wound under pressure in a plurality of overlapping spiral windings without a separate adhesive material or layer between adjacent layers of said film web or webs onto an outer surface of said pipeline length with sufficient layer numbers to form a barrier zone adapted, in use, to prevent moisture penetrating from an outer surface of said barrier zone to the outer surface of said pipeline length, and wherein at least one further plastics material film web is wound in a plurality of overlapping spiral windings over said barrier zone with the further film web or webs being at least partially adhered to one another to form a second outer protective zone, and wherein the further plastics material film web or webs in said second outer protective zone are wound more loosely than the plastics material film web or webs forming said barrier zone.

29. A pipeline length according to claim 28 wherein a plurality of air pockets or spaces are located between overlying regions of the or each said further plastics material film web or webs in said second outer protective zone.

30. A pipeline length according to claim 28 wherein the or each said plastics material film web forming the barrier zone is initially stretched beyond its yield point to increase its length and decrease its thickness and thereafter allowed to partially relax to retain a portion of the elastic deformation in said film web or webs prior to application to said pipeline length whereby said film web or webs will further apply pressure to said pipeline length after application thereto.

31. A pipeline length according to claim 28 wherein the or each said plastics material film web forming the barrier zone is a multilayer co-extruded film web wherein at least one layer of the co-extruded film web acts as an oxygen transmission barrier layer.
